(19) United States
(12) Patent Application Publication
(10) Pub. No.: US 2009/0142459 A1
(43) Pub. Date: Jun. 4, 2009

(54) PROCESS FOR DEMINERALIZING WHEY AND PRODUCT THEREFROM

(76) Inventor: Bruce T. Batchelder, Alton Bay, NH (US)

Correspondence Address: General Electric Company;GE Global Patent Operation, PO Box 861, 2 Corporate Drive, Suite 648, Shelton, CT, 06484, US

(21) Appl. No.: 12/326,158

(22) Filed: Dec. 2, 2008

Related U.S. Application Data
(60) Provisional application No. 60/991,882, filed on Dec. 3, 2007.

(51) Int. Cl. A23C 9/144; A23C 21/00; A23C 9/146

(52) U.S. Cl. 426/239; 426/583; 426/271

(57) ABSTRACT

A process has been found for demineralizing whey which results in usable by-product streams, comprising softening the whey, and then applying bipolar electrodialysis to the softened whey to recover valuable by-products and product streams, demineralized whey, dilute acid and dilute caustic.

### FIELD OF THE INVENTION

The present application is related to a process for demineralizing whey, and more particularly to an improved process for demineralizing whey using bipolar membrane electrodialysis that results in reusable by-products.

### BACKGROUND OF THE INVENTION

Whey is a by-product of the conversion of milk into cheese, casein or casein derivatives. The utilization of this by-product is necessary to reduce the volume of effluents that have to be treated in purification plants. Most whey is dried to form a powder, which is used in various applications, such as for example, in animal feed mixes. Other uses, which enable a better added value to be obtained, such as for use in infant formulas or other food applications, necessitate the demineralization of the whey.

In theory, demineralization should be possible by ultra-filtration or reverse osmosis, but reverse osmosis is too specific and ultrafiltration is accompanied by a significant loss of lactose, a valuable, recoverable sugar. In practice, two different processes have generally been used, either separately or in combination, to demineralize whey, namely, electrodialysis and ion exchange.

In electrodialysis, the ionized salts of a solution migrate under the effect of an electrical field through membranes selectively permeable to the cations and the anions. This method promotes elimination of the ions but produces a brine effluent stream.

Ion exchange makes use of the ionic equilibria existing between a solid phase (the resin) and a liquid phase (the product to be demineralized). This technique is based on the phenomena of affinity and exclusion according to which the liquid leaves the undesirable ions in the saturation or exhaustion phase of the resin, the undesirable ions being replaced by the selected ions with which the ion exchanger had been charged beforehand during the regeneration phase. Large quantities of water are required, an abundance of regeneration agents have to be used and it is difficult to know what to do with these reagents after use.

U.S. Pat. No. 4,138,501 discloses and claims a process for treating whey that combines both electrodialysis and ion exchange. The process requires two stages, with the initial stage comprising electrodialysis, after which partially demineralized whey is recovered as an intermediate product. The intermediate whey product is then subject to ion exchange in which the majority of remaining mineral ions are removed.

As shown in FIG. 1, a conventional whey demineralization process 100 comprises a whey source 110 from for example cheese or casein production. That whey source 110 is then subjection to preconcentration 120 by means known in the art, including evaporation, reverse osmosis or nanofiltation. The preconcentration 120 is followed by conventional electrodialysis 130, from which the brine effluent 160 is removed and the product of the electrodialysis proceeds onto an optional ion exchange 140, and thereafter onto final processing 150, including but not limited to evaporation, drying and bagging of the demineralized whey product.

Unfortunately, the use of either of these process results in by-products that are not easily disposed. In particular, a by-product stream is created which contains, as salts, the minerals removed from the whey. This salty stream, in part due to its high content of Cl and Na, creates an effluent disposal problem.

Bipolar membrane electrodialysis, also referred to as water splitting, is a method useful for producing acid and base solutions from salt streams. Under the force of an electrical field, a bipolar membrane will efficiently dissociate water into hydrogen (H+) and hydroxyl (OH—) ions. A bipolar membrane is formed of an anion and a cation exchange layer that are bound together either physically or chemically, and a very thin interface where the water diffuses from the outside aqueous salt solutions.

Accordingly, a need exists for a process that would provide for the demineralization of whey, but not result in by-products that have a significant disposal cost or create environmental problems.

### SUMMARY OF THE INVENTION

A process has been found for demineralizing whey that results in usable by-products while requiring fewer steps to produce the same, and is thus more economical.

According to one embodiment, whey is demineralized using bipolar electrodialysis, which allows for the direct production of acid and caustic byproducts while significantly reducing the salt streams. One application of the present invention provides for an additional step prior to bipolar electrodialysis, a process is used to soften the whey, allowing the bipolar electrodialysis to be applied directly to the process solution without concern for hardness precipitation.

In a further alternative embodiment of the invention, the same process is applied to any organic solution which requires desalting and which also contains some degree of mineral hardness.

The various features of novelty that characterize the invention are pointed out with particularity in the claims annexed to and forming a part of this disclosure. Changes to and substitutions of the various components of the invention can of course be made. The invention resides as well in sub-combinations and sub-systems of the elements described, and in methods of using them.

### BRIEF DESCRIPTION OF THE DRAWINGS

Refer now to the figures, which are meant to be exemplary and not limiting, and wherein like elements are numbered alike, and not all numbers are repeated in every figure for clarity of the illustration.

FIG. 1 is an illustration of a conventional whey demineralization process known in the art.

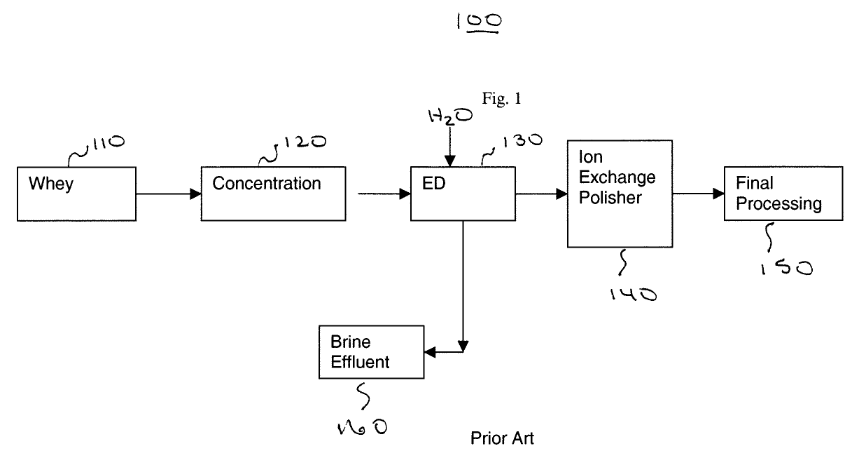

FIG. 2 is an illustration of a whey demineralization process according to an embodiment of the present invention.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

A process has been found for demineralizing whey that results in usable by-product streams. According to one embodiment, bipolar electrodialysis is used which allows for the recovery of acid and caustic from salt streams. However, prior to the application of bipolar electrodialysis, a process is used to soften the whey by removing calcium and magnesium hardness, thereby allowing the bipolar dialysis to be applied directly to the process solution, thereby demineralizing the whey. This results in three valuable products and product streams, demineralized whey, dilute acid and dilute caustic. All of these streams can be used in further processes.

In one embodiment of the present application, the whey is processed first by subjection it to softening by a cationic ion exchange step. In the cationic softener the whey is softened by removing Ca and Mg from the whey. The whey is loaded into a column containing resins that have the property of substituting Na ions for Ca and Mg ions.

The ion exchange is operated under conditions that would be known to those in the art, including flow rates and resin bed density. The ion exchange process may be carried out a temperature of from about 4 to about 50° C., preferably at a temperature of about 10 to about 20° C. Processing time may range from about one (1) to about six (6) hours.

An embodiment of the process provides for a second step after the softening of the whey to remove hardness, wherein the resulting whey product is then passed through bipolar electrodialysis. Bipolar electrodialysis, also known as water splitting, efficiently dissociates water into hydrogen (H+) and hydroxyl (OH—) ions. By using bipolar electrodialysis as a second step, whey is demineralized and the mineral ions that are removed are collected in the form of dilute acid and dilute caustic suitable for reuse or recycling.

In bipolar electrodialysis, a three compartment cell is obtained by placing a bipolar membrane within a conventional electrodialysis cell. The bipolar membrane is flanked on either side by the anion and cation exchange membranes to form three compartments. The three compartments comprise the acid between the bipolar and the anion exchange membranes, the base between the bipolar and the cation exchange membranes and whey between the cation and anion exchange membranes. As in conventional electrodialysis stacks, many cells can be installed in one stack, and a system of manifolds can feed all the corresponding compartments in parallel, creating three circuits across the stack; acid, base and whey product.

In one embodiment of the present application, the bipolar membrane is used on the softened whey to demineralize it. During the demineralization process, sodium (Na), chlorine (Cl) and other mineral ions are removed from the whey solution. In the bipolar process, under the influence of the electric field, water is dissociated in the bipolar membrane to form hydroxide ions and hydrogen protons. In the presently claimed process, Na combines with the hydroxyl stream of water to form sodium hydroxide and the chlorine combines with the hydrogen to form hydrochloric acid. A result of the presently disclosed process is that the former effluent stream is, replaced by dilute acid and caustic streams. They can be collected and reused or recycled, examples of use include but are not limited to regenerating ion exchange columns, clean-in-place procedures, and neutralization. Operating temperatures should be in the range of from about 5 to about 60° C., and more specifically from about 20 to about 50° C. The flow rates through the unit may range from about five (5) to about thirty (30) cubic meters per hour. Use of the combined two-step process can result in demineralization up to about 90%.

By using a two-step process comprising cationic ion exchange to soften the whey and then bipolar electrodialysis for demineralization, a number of advantages are realized over processes known in the industry and to those skilled in the art. Specifically, as the bipolar electrodialysis results in the distinct dilute effluent streams, i.e. acidic and caustic, a further processing step is eliminated, which therefore makes the process more economical, more eco-friendly as there is a lower power usage, and more time efficient.

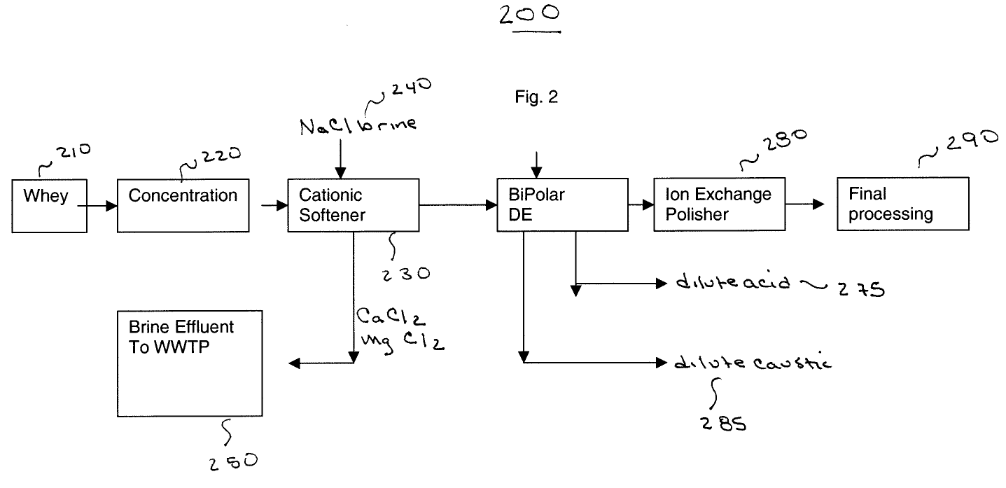

Looking now to FIG. 2, an improved whey demineralization process 200 according to an embodiment of the present invention. Whey 210 is provided, and may come from a variety of sources, including cheese or casein production. The whey 210 is subjection to concentration 220 so that the whey has a total solids level of from about 18 to about 24%. Such concentration 220 can be accomplished by a number of possible means, including but not limited to evaporation, reverse osmosis or nanofiltation. The concentrated whey then proceeds to a cationic softener 230, to which sodium chloride brine 240 is also added. The softener substitutes the sodium provided in the sodium chloride brine 240 for the calcium and magnesium in the concentrated whey. The calcium and magnesium are removed from the softener 230 in the form of calcium chloride and magnesium chloride, and proceed as brine effluent to further treatment, such as in a wastewater treatment plant. Note that in an alternate embodiment, it is possible to switch the order of the concentration and softening steps such that the softening may occur prior to the concentration.

The softened whey product proceeds on to bipolar electrodialysis (ED) 260. Water 270 is also fed directly into the bipolar ED, where about 40 to about 90% of mineral ash is removed. Additionally, during the bipolar ED process, dilute acid 275 and dilute caustic 285 waste streams are produced. The dilute acid stream 275 comprises HCl and is from about 2 to about 5% by weight and the dilute caustic stream 285 comprises sodium hydroxide at levels of from about 2 to about 5% by weight. These dilute streams may be recycled or reused in their present form. After the Bipolar ED 260, the whey stream may then go through the further step of ion exchange polisher 280 to increase the demineralization of the whey up to about 95%. Thereafter, the demineralized whey is subject to final processing 290, including for example, but not limited to, evaporation, drying and bagging.

In a further alternative embodiment of the invention, it is possible to extend this process to other applications, specifically the same process may be applied to any process solution which requires desalting and which also contains some degree of hardness. A product may be subjected to ion exchange to decrease or remove hardness and then subsequently subjected to bipolar electrodialysis to desalt the product.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A process for demineralizing whey comprising:
a) softening the whey by use of cationic ion exchange; and
b) subjecting the product of step a to bipolar electodialysis.

2. The process of claim 2 which results in diluted caustic and acidic byproduct streams.

3. The process of claim 1 wherein the softening removes calcium and magnesium from the whey.

4. The process of claim 2 wherein the byproduct streams comprise sodium hydroxide and hydrochloric acid.

5. The process of claim 1 wherein the cationic ion exchange is carried out a temperature of from about 4 to about 50° C.

6. The process of claim 5 wherein the cationic ion exchange is carried out a temperature of from about 10 to about 20° C.

7. The process of claim 1 wherein the demineralization process can result in demineralization up to about 90%.

8. The process of claim 2 wherein the effluent streams are reused.

9. The process of claim 2 wherein the effluent streams are recycled.

10. The process of claim 1 which further comprises a concentration step, wherein the whey is concentrated prior to softening.

11. The process of claim 1 which comprises subjecting the whey to an ion exchange polisher subsequent to the bipolar electrodialysis.

12. The process of claim 11 wherein the demineralization levels are up to about 95%.

13. A process for demineralizing whey, comprising:
a) concentrating the whey;
b) softening the concentrated whey;
c) subjecting the softened, concentrated whey to bipolar electrodialysis;
d) passing the whey product from c) through an ion exchange polisher to produce the final demineralized whey; and
e) subjecting the demineralized whey of d) to evaporation, drying and bagging.

14. The demineralized whey product produced in accordance with claim 13.

15. A process for desalting and reducing hardness of a product comprising;
a) subjecting the product to an ion exchange process, and
b) subsequently subjecting the results of step a to bipolar deionization.
